(19) United States
(12) Patent Application Publication
(10) Pub. No.: US 2003/0032557 A1
(43) Pub. Date: Feb. 13, 2003

(54) Imaging medium incorporating block copolymers as a dispersant for leuco dye

(76) Inventors: Jayprakash C. Bhatt, Waltham, MA (US); Daoshen Bi, Burlington, MA (US); Kuang-Chou Chang, Lexington, MA (US); Feng Y. Dai, Framingham, MA (US); Lloyd Taylor, Lexington, MA (US)

Correspondence Address: Stephen J. Gaudet, POLAROID CORPORATION, Patent Department, 784 Memorial Drive, Cambridge, MA, 02139, US

(21) Appl. No.: 09/969,677

(22) Filed: Oct. 3, 2001

Related U.S. Application Data
(60) Provisional application No. 60/294,472, filed on May 30, 2001.

(51) Int. Cl. B41M 5/30

(52) U.S. Cl. 503/209

(57) ABSTRACT

Disclosed herein is an imaging medium comprising a substrate carrying a color-change layer which develops color upon heating. The addition of a novel block copolymer surfactant containing ethylene oxide (EO) and propylene oxide (PO) into the leuco dye dispersion prevents color pre-formation during the dispersion preparation stage, and in the final coating fluid in the presence of developers and acids. The pluronic may complex the acid developer as well as the final image dye.

### RELATED APPLICATIONS

The present application is related to copending provisional patent application filed in the United States Patent and Trademark Office on May 30, 2001, having Serial No. 60/294,472 and entitled “Imaging Medium Incorporating Block Copolymers As A Dispersant For Leuco Dye”.

### BACKGROUND OF THE INVENTION

This invention relates to a heat sensitive imaging medium incorporating novel block copolymer surfactant containing ethylene oxide (EO) and propylene oxide (PO) into the preparation of leuco dye dispersion. The use of EO-PO co-polymers for the preparation of the leuco dye dispersion prevents color pre-formation during the dispersion preparation stage, and in the final coating fluid in the presence of developers and acids. The EO-PO co-polymer surfactants with trade name of Pluronic [available from BASF Corporation] provide improved Dmin.

Generally, a thermosensitive recording material comprises a support and a thermosensitive coloring layer formed thereon, which comprises as the main components a colorless or light colored dye precursor, and a color developer. The dye precursor and color developer react instantaneously upon the application of heat thereto to produce recorded images, for instance, using a thermal head, heat pen or laser beam.

Thermally sensitive recording material is used in a wide variety of fields, for example, as the recording material for an electronic computer, facsimile apparatus, ticket vending apparatus, label printer, and recorder because it has the advantages that recording can be achieved using a relatively simple apparatus, maintenance is simple, and they are typically quiet.

Direct thermal printers are well known in the prior art. Typically, a coated paper is heated, causing a color change due to a chemical reaction. Chelate recording papers use salts of organic acids and organic reducing agents to produce an image. Leuco dye media are known which contain colorless dye precursors and dye

developers. When heated, the acidic dye developer reacts with the dye precursor, producing a color change. Using these systems, it has in the past been difficult to obtain highly detailed images, thus limiting the utility of the printers.

Printers based upon a process known as “thermal wax transfer”, or, more correctly, “thermal mass transfer” are available commercially. Such printers use an imaging medium (usually called a “donor sheet” or “donor web”) which, in the case of a color printer, comprises a series of panels of differing colors. Each panel comprises a substrate, typically a plastic film, carrying a layer of fusible material, conventionally a wax, containing a dye or pigment of the relevant color. To effect printing, a panel is contacted with a receiving sheet, which can be paper or a similar material, and passed across a thermal printing head, which effects imagewise heating of the panel. At each pixel where heat is applied by the thermal head, the layer of fusible material containing the dye or pigment transfers from the substrate to the receiving sheet, thereby forming an image on the receiving sheet. To form a full color image, the printing operation is repeated with panels of differing colors so that three or four images of different colors are superposed on a single receiving sheet.

Thermal wax transfer printing is relatively inexpensive and yields images which are good enough for many purposes. However, the resolution of the images which can be produced in practice is restricted since the separation between adjacent pixels is at least equal to the spacing between adjacent heating elements in the thermal head, and this spacing is subject to mechanical and electrical constraints. Also, the process is essentially binary; any specific pixel on one donor panel either transfers or does not, so that producing continuous tone images requires the use of dithering, stochastic screening or similar techniques to simulate continuous tone. Finally, some difficulties arise in accurately controlling the color of the images produced. The size of the wax particle transferred tends to vary depending upon whether an isolated pixel, or a series of adjacent pixels are being transferred, and this introduces granularity into the image and may lead to difficulty in accurate control of gray scale. Also, any given pixel in the final image may have 0, 1, 2, 3 or 4 superimposed wax particles, and the effects of the upper particles upon the color of the lower particles may lead to problems in accurate control of color balance.

Printers are also known using a process known as “dye diffusion thermal transfer” or “dye sublimation transfer”. This process is generally similar to thermal wax transfer in that a series of panels of different colors are placed in succession in contact with a receiving sheet, and heat is imagewise applied to the panels by means of a thermal head to transfer dye from the panels to the receiving sheet. In dye diffusion thermal transfer processes, however, there is no mass transfer of a binder containing a dye; instead a highly diffusible dye is used, and this dye alone transfers from the panel to the receiving sheet without any accompanying binder. Dye diffusion thermal transfer processes have the advantages of being inherently continuous tone (the amount of dye transferred at any specific pixel can be varied over a wide range by controlling the heat input to that pixel of the panel) and can produce images of photographic quality. However, the process is expensive because special dyes having high diffusivity, and a special receiving sheet, are required. Also, this special receiving sheet usually has a glossy surface similar to that of a photographic print paper, and the glossy receiving sheet limits the types of images which can be produced; one cannot, for example, produce a image with a matte finish similar to that produced by printing on plain paper, and images with such a matte finish may be desirable in certain applications. Finally, problems may be encountered with images produced by dye diffusion thermal transfer because the highly diffusible dyes tend to “bleed” within the image, for example, when contacted by oils from the fingers of users handling the images.

Finally, there is one thermal imaging system, described in, inter alia, U.S. Pat. Nos. 4,771,032; 5,409,880; 5,410,335; 5,486,856; and 5,537,140, and sold by Fuji Photo Film Co., Ltd. under the Registered Trademark “AUTOCHROME” which does not depend upon transfer of a dye, with or without a binder or carrier, from a donor to a receiving sheet. This process uses a recording sheet having three separate superposed color-forming layers, each of which develops a different color upon heating. The top color-forming layer develops color at a lower temperature than the middle color-forming layer, which in turn develops color at a lower temperature than the bottom color-forming layer. Also, at least the top and middle color-forming layers can be deactivated by actinic radiation of a specific wavelength (the wavelength for each color-forming layer being different, but both typically being in the near ultra-violet) so that after deactivation the color-forming layer will not generate color upon heating.

This recording sheet is imaged by first imagewise heating the sheet so that color is developed in the top color-forming layer, the heating being controlled so that no color is developed in either of the other two color-forming layers. The sheet is next passed beneath a radiation source of a wavelength which deactivates the top color-forming layer, but does not deactivate the middle color-forming layer. The sheet is then again imagewise heated by the thermal head, but with the head producing more heat than in the first pass, so that color is developed in the middle color-forming layer, and the sheet is passed beneath a radiation source of a wavelength which deactivates the middle color-forming layer. Finally, the sheet is again imagewise heated by the thermal head, but with the head producing more heat than in the second pass, so that color is developed in the bottom color-forming layer.

In such a process, it is difficult to avoid crosstalk between the three color-forming layers since, for example, if it is desired to image an area of the top color-forming layer to maximum optical density, it is difficult to avoid some color formation in the middle color-forming layer. Insulating layers may be provided between the color-forming layers to reduce such crosstalk, but the provision of such insulating layers adds to the cost of the medium. Print energy tends to be high, since the third pass over the thermal head to form color in the bottom color-forming layer requires heating of this layer through two superposed color-forming layers, and two insulating layers, if these are present. Finally, the need for at least two radiation sources to produce two well-separated wavelengths adds to the cost and complexity of the apparatus required.

Leuco dye chemistry has been widely adopted for use in thermal imaging applications including direct thermal paper, carbonless paper and point-of-sale receipts. Although leuco dyes may provide full gray scale for full color images, image stability has been problematic. Specifically, obtaining adequate Dₘᵢₙ and Dₘₐₓ simultaneously is difficult using leuco dyes.

The image forming reaction based upon leuco dye chemistry has long been acknowledged as an acid-base reaction between a basic leuco dye and a weak acidic developer. Commonly used acidic developers include phenol derivatives such as bisphenol-A, benzyl paraben, monohydroxy and dihydroxy diphenyl sulfones, acidic clays, phenolic resins and zinc salicylates. Adequate Dₘᵢₙ stability may be obtained using the phenol derivatives. These compounds also provide high density at low print energy, however, they do not provide acceptable Dₘₐₓ stability. Good Dₘₐₓ stability may be obtained using phenolic resins and zinc salicyates, but these compounds are known to provide poor Dₘᵢₙ stability.

This invention discloses an imaging medium containing novel EO-PO copolymer dispersants for leuco dyes. Specifically, block copolymers of polyethylene oxide and polypropylene oxide are disclosed as surfactants for use in lactone dyes. Use of these copolymers provides improved Dmin and Dmax control, allowing highly detailed images to be produced using direct thermal media.

### DETAILED DESCRIPTION

As indicated, the present invention provides an imaging medium comprising a substrate carrying a color-change layer which develops color upon heating.

In some types of direct thermal media, an image layer is prepared consisting of dispersed developers or acids with a dispersed leuco dye in a water borne coating. One of the common problems of this approach is the pre-formation of color when mixing the dispersions of leuco dye with developers. This color pre-formation raises the sensitometric Dmin of the leuco dye layer before thermal printing.

The pre-formation of color could also be detected from the prepared leuco dye dispersion. The leuco dye dispersion is prepared with an appropriate amount of surfactant of anionic type such as sulfate, ester, or sulfonate salt-type anionic surfactants The use of these surfactants usually results in high pH (8.0˜9.5) of the final leuco dye dispersion. When the leuco dye dispersion is mixed with developers and/or acid to prepare the coating fluid, the pH of coating fluid is decreased down to 7, proton transfer between leuco dye and developers is intensified which results in the color formation of the leuco dye.

The addition of a novel block copolymer surfactant containing ethylene oxide (EO) and propylene oxide (PO) into the leuco dye dispersion prevents color pre-formation during the dispersion preparation stage, and in the final coating fluid in the presence of developers and acids. The pluronic may complex the acid developer as well as the final image dye.

Very desirably, the color-forming reagents used in the processes and medium of the present invention are such that the density of the color developed as a result of the color change in the color-change layer varies with the thermal energy input to this layer. By using such color-forming reagents and varying the imagewise heating (in the imagewise-heating process) one can produce in the final image colored pixels of color-change layer having differing color densities, thus producing a continuous tone image, in contrast to the essentially binary images produced by conventional thermal mass transfer processes.

As the leuco dye for use in the present invention, which may be employed alone or in combination, any conventional dyes for use in the conventional leuco-dye-containing recording materials can be employed. For example, triphenylmethanephthalide leuco compounds, triallylmethane leuco compounds, fluoran leuco compounds, phenothiazine leuco compounds, thiofluoran leuco compounds, xanthene leuco compounds, indophthalyl leuco compounds, spiropyran leuco compounds, azaphthalide leuco compounds, couromeno-pyrazole leuco compounds, methine leuco compounds, rhodamineanilino-lactam leuco compounds, rhodaminelactam leuco compounds, quinazoline leuco compounds, diazaxanthene leuco compounds and bislactone leuco compounds are preferably employed.

The polyhydroxystyrene used as a developer or co-developer in the present invention may be utilized in linear, branched and co-polymer forms is available from Triquest, LP, Dallas, Tex.

The color co-developer of the present invention may be any of the aromatic phenol color developers known or used in the thermal media art to form a colored reaction product. The preferred co-developers are selected from the group of commonly used acidic developers such as bisphenol-A, benzyl paraben, dihydroxy diphenyl sulfone, acid clays, phenolic resins and zinc salicylates. A general review of color developers useful in color-forming reactions can be found in James, T. H., The Theory of the Photographic Process, 4th Ed., MacMillian Publishing Co., Inc., New York, N.Y. (1977), in particular at pages 335 through 362.

In addition to the color-forming reagents, the color-forming layer will normally comprise a binder. The binders used in conventional thermal wax transfer imaging, for example natural or synthetic waxes or resins, may also be used in the present imaging medium. Ultra-violet absorbers may also be incorporated into this color-change layer to improve the light stability of the image.

The exact nature of the substrate used in the present imaging medium is not critical provided that this substrate provides adequate mechanical support for the color-change layer during storage, transport and imaging, has sufficient thermal conductivity not to interfere with the imaging process. Typically, the substrate will be a plastic film, such as that sold under the Registered Trademark “Melinex” by Du Pont De Nemours Eli & Corporation, Martinsville, Va. After imaging, various post-treatment steps may be effected to vary the appearance of and/or to protect the image. For example, the image may be subjected to heat treatment to change its gloss, and may have a protective laminate secured over the color-change layer(s) to change the image's appearance or to protect it from mechanical damage.

The present invention will be described in greater detail with reference to the following examples, which are in no way limiting.

### EXAMPLES

### Example 1

### Leuco Magenta Dye dispersion

A Copikem 16 (Hilton Davis) was used as magenta leuco dye. The leuco dye was dispersed in a two-surfactant system comprising the composition as shown in Table 1 below using an attriter with glass beads and stirred at 400 rpm, torque=12˜15 units, for 18˜20 hours at room temperature. An anionic-type Aerosol OT-75 (Cytec Industries Inc.) was used as the first surfactant, which improved the wetting of the leuco dye powder and helped to reduce the particle sizes. The EO and PO block copolymer surfactants used in the current invention are various Pluronic surfactants (BASF); the Pluronic surfactant was added as the second surfactant.

TABLE 1
Formulation of Leuco Dye Dispersion

| Ingredient | Weight % solids | Remark |
|---|---|---|
| Copikem 16 | 92.50% | Magenta Dye |
| Aerosol-OT | 4.0% | Surfactant |
| Pluronic surfactant | 1.5% | |
| PVA 205 | 2.0% | Partially hydrolyzed |
| | | poly(vinylalcohol) |

### Example 2

### Developer Dispersions

Phenol-4,4′-sulfonyl bis-2-(2-propenyl) (TG-SA, Nippon Kayaku Co.) (92.27 wt %) was dispersed in an aqueous mixture comprising of 3.69 wt % PVA205 (Air Products), 3.23 wt % DOWFAX-2A1 (Dow Chemicals), 0.81 wt % Pluronic 25R2 surfactants and deionized water with attrition technique. The attrition of total solid ˜30% was performed with the same attriter under the condition of 500 rpm and torque=15 units for 18 hours at room temperature. The average particle size of the resulting dispersion was 0.2˜0.6 μm.

A dispersion of poly(hydroxystyrene) is prepared by attriting a mixture consisting of poly(hydroxystyrene) with Irganox 1035 [Ciba Specialty Chemicals], surfactant Dowfax 2A1 [Dow Chemicals], partially hydrolyzed poly(vinylalcohol) and deionized water. The mixture was attrited for 18-24 hr at 2-4° C. resulting in a dispersion with an average particle size of 0.4-0.7 μm.

TABLE 3
Pluronic Surfactants Used for Dispersing Magenta Leuco Dye

| Surfactants | MW of PO | wt % EO in the molecule | Dmin |
|---|---|---|---|
| Pluronic L43 | 1200 | 30 | 0.14 |
| Pluronic L62 | 1800 | 20 | 0.07 |
| Pluronic 17R2 | 1700 | 20 | 0.13 |
| Pluronic 17R4 | 1700 | 40 | 0.15 |
| Pluronic 25R2 | 2500 | 20 | 0.07 |
| Pluronic 25R1 | 2500 | 10 | 0.11 |
| Pluronic 25R4 | 2500 | 40 | 0.14 |
| Pluronic 31R1 | 3100 | 10 | 0.10 |
| Pluronic 31R2 | 3100 | 20 | 0.12 |

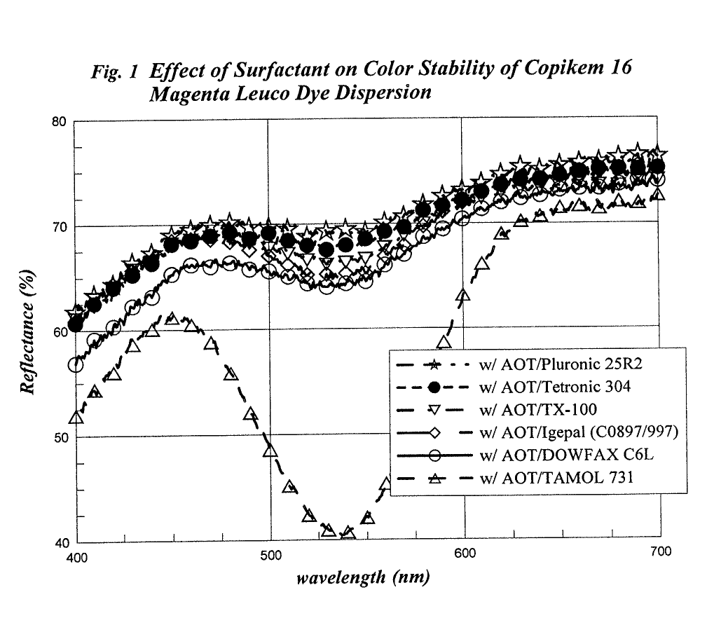

The color of magenta dye dispersion prepared with and without the Pluronic surfactant were also characterized using diffuse reflectance spectroscopy and is shown in FIG. 1. It is evident that the magenta leuco dye prepared with the use of anionic surfactants (TAMOL 731 and DOWFAX C6L) showed more intensified magenta color, i.e., less reflectance band shown between 450˜620 nm, than those prepared with the use of non-ionic surfactants (Pluronic 25R2, Tetronic 304, Triton-X100 and Igepal). TAMOL 731 can be obtained from Rohm and Haas, DOWFAX C6L can be obtained from Dow Chemical, Tetronic 304 can be obtained from BASF, Triton-X100 can be obtained from Union Carbide and Igepal can be obtained from Rhodia. Among different non-ionic surfactants, Pluronic 25R2 performed the best.

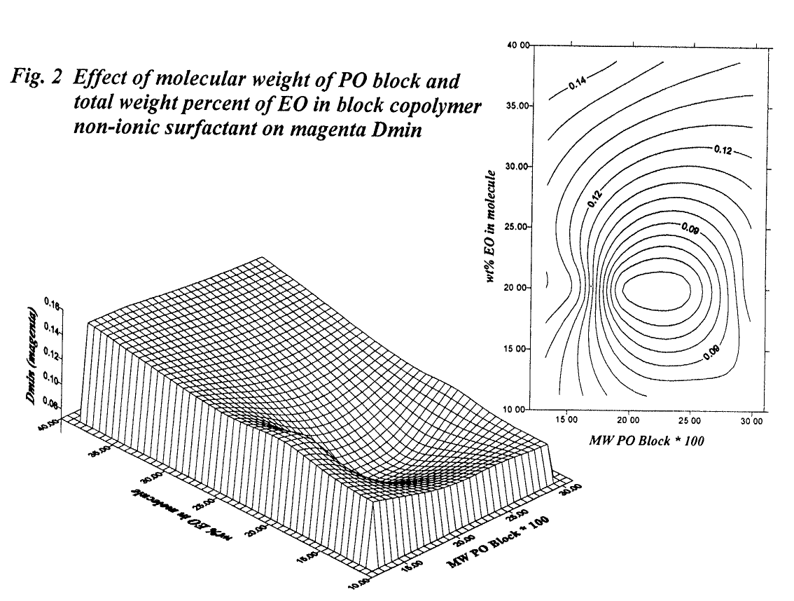

The characteristics of different Pluronic surfactant used for dispersing the magenta dye and the measured Dₘᵢₙ of the coated media were plotted in a 3-D diagram and a contour plot, as in FIG. 2, to show an optimum condition for obtaining low Dmin. Thus it appears that the Pluronics that are rich in PO blocks show the best results in keeping both the dispersions and also the film very low in Dmin.

The magenta dye dispersion was mixed with acid developers TG-SA and poly(hydroxystyrene) [PHS] dispersions and styrene-butadiene latex binder [Genflo 3056, available from Omnova Solutions, Fairlawn, Ohio] to make a coating fluid comprising the formulation shown in Table 2. The coating fluid was then coated with Mayer Rod on to a 3.80 mL poly(ethyleneterphthalate) film [Melinex 534, available form DuPont] with the intended coating thickness of 3.0 μm. The coating was air dried in an oven at 60° C.

TABLE 2
Composition for Magenta Coating Fluid

| Ingredient | % solid in dry film |
|---|---|
| Copikem 16 | 10.0% |
| TG-SA | 30.0% |
| Poly(hydroxystyrene) | 15.0% |
| Genflo 3056 binder | 45.0% |

Different Pluronic surfactants were used for the magenta dispersion and were evaluated. Table 3 shows the different surfactants used for preparing the dye dispersion, the characteristics of the pluronic surfactant and the measured Dₘᵢₙ of the media prepared using these dispersion.

TABLE 3
Pluronic Surfactants Used for Dispersing Magenta Leuco Dye

| Surfactants | MW of PO | wt % EO in the molecule | Dmin |
|---|---|---|---|
| Pluronic L43 | 1200 | 30 | 0.14 |
| Pluronic L62 | 1800 | 20 | 0.07 |
| Pluronic 17R2 | 1700 | 20 | 0.13 |
| Pluronic 17R4 | 1700 | 40 | 0.15 |
| Pluronic 25R2 | 2500 | 20 | 0.07 |
| Pluronic 25R1 | 2500 | 10 | 0.11 |
| Pluronic 25R4 | 2500 | 40 | 0.14 |
| Pluronic 31R1 | 3100 | 10 | 0.10 |
| Pluronic 31R2 | 3100 | 20 | 0.12 |

The color of magenta dye dispersion prepared with and without the Pluronic surfactant were also characterized using diffuse reflectance spectroscopy and is shown in FIG. 1. It is evident that the magenta leuco dye prepared with the use of anionic surfactants (TAMOL 731 and DOWFAX C6L) showed more intensified magenta color, i.e., less reflectance band shown between 450˜620 nm, than those prepared with the use of non-ionic surfactants (Pluronic 25R2, Tetronic 304, Triton-X100 and Igepal). TAMOL 731 can be obtained from Rohm and Haas, DOWFAX C6L can be obtained from Dow Chemical, Tetronic 304 can be obtained from BASF, Triton-X100 can be obtained from Union Carbide and Igepal can be obtained from Rhodia. Among different non-ionic surfactants, Pluronic 25R2 performed the best.

The characteristics of different Pluronic surfactant used for dispersing the magenta dye and the measured Dₘᵢₙ of the coated media were plotted in a 3-D diagram and a contour plot, as in FIG. 2, to show an optimum condition for obtaining low Dmin. Thus it appears that the Pluronics that are rich in PO blocks show the best results in keeping both the dispersions and also the film very low in Dmin.

### Example 3

### Leuco Black Dye Dispersions

A Copikem 34 (Hilton Davis) was used as black leuco dye. Table 4 shows the composition of dispersions of the black leuco dye made with and without pluronic surfactants and the measured Dₘᵢₙ of coated media. All the dispersions were made at 25.0% solid content by attrition using glass beads and stirred at 400 rpm, torque=12˜15 units, for 18˜20 hours at room temperature.

The coated media was prepared by making coating fluid as shown in Table 5 and coating the fluid on a 6.0 mL super smooth white polypropylene substrate [obtained from Yupo Corporation] with a desired coating coverage of 3.34 μm. The polypropylene substrate had a background Dₘᵢₙ of 0.02 units.

TABLE 4
Composition of Dispersions of Leuco Black Dye and the Dₘᵢₙ Using These
Dispersions in the Coating Fluid

| | Ingredients | | Ionic | | |
|---|---|---|---|---|---|
| | Dye 91.75%, and PVA205 | | Conductivity | | Dₘᵢₙ |
| Sample # | 4.50% | | mS/cm | pH | (Black) |
| 1 | Aerosol-OT | Pluronic 25R2 | 1.18 | 8.3 | 0.04 |
| | d 2.75% | 1.00% | | | |
| 2 | Dowfax 2A1 | | 2.19 | 9.5 | 0.06 |
| | 3.75% | | | | |
| 3 | Tamol 731 | | 3.04 | 8.9 | 0.14 |
| | 3.75% | | | | |
| 4 | Aerosol-OT | | 31.35 | 9.5 | 0.05 |
| | 3.75% | | | | |
| 5 | Aerosdol-OT | Pluronic 25R2 | 0.98 | 7.5 | 0.02 |
| | 1.00% | 2.75% | | | |
| 6 | Aerosol-OT | Pluronic 31R1 | 0.98 | 7.7 | 0.04 |
| | 1.00% | 2.75% | | | |
| 7 | Aerosol-OT | Pluronic 25R4 | 0.67 | 7.7 | 0.03 |
| | 1.00% | 2.75% | | | |
| 8 | Aerosol-OT | Pluronic 17R4 | 1.16 | 7.7 | 0.05 |
| | 1.00% | 2.75% | | | |
| 9 | Aerosol-OT | Pluronic L62 | 1.30 | 7.8 | 0.04 |
| | 1.00% | 2.75% | | | |

TABLE 5
Coating Fluid Formulations

| | % solids for Stock | % solid in coated | Weight |
|---|---|---|---|
| Ingredient | dispersion | film | (gm) |
| Copikem 34 dye | 25.0% | 10.0% | 0.87 |
| TG-SA developer | 29.3% | 30.0% | 2.22 |
| Poly(hydroxystyrene) | 20.0% | 15.0% | 1.50 |
| PVA 205 | 20.0% | 45.0% | 4.45 |
| D.I. Water | | | 0.96 |
| Total | | 100.0% | 10.00 |

What is claimed is:

1. A thermosensitive recording material, comprising:
a thermosensitive coloring layer, wherein said coloring layer comprises
a developer and a dye precursor, wherein said dye precursor comprises a leuco dye dispersion agent, and wherein said leuco dye dispersion agent comprises ethylene oxide and propylene oxide; and
a support.

2. The recording material of claim 1, wherein said leuco dye dispersion agent is selected from the group consisting of a triphenylmethanephthalide leuco compound, triallymethane leuco compound, fluoran leuco compound, phenothiazine leuco compound, thiofluoran leuco compound, xanthene leuco compound, indophthalyl leuco compound, spiropyran leuco compound, azaphthalide leuco compound, couromeno-pyrazole leuco compound, rhodaminelactam leuco compound, quinazoline leuco compound, diazaxanthene leuco compound, methine leuco compound, rhodamineanilino-lactam leuco compound, bislactone leuco compound, and combinations thereof.

3. The recording material of claim 1, wherein said developer is poly(hydroxystyrene).

4. The recording material of claim 3, wherein said poly(hydroxystyrene) is linear.

5. The recording material of claim 3, wherein said poly(hydroxystyrene) is branched.

6. The recording material of claim 1 further comprises a co-developer.

7. The recording material of claim 6, wherein said co-developer is selected from a group consisting of bisphenol-A, benzyl paraben, dihydroxy diphenyl sulfone, an acid clay, a phenolic resin, and a zinc salicylates.

8. The recording material of claim 1, wherein said coloring layer comprises a binder.

9. The recording material of claim 8, wherein said binder is a natural wax or resin.

10. The recording material of claim 8, wherein said binder is a synthetic wax or resin.

11. The recording material of claim 8, wherein said binder is a water-soluble polymer.

12. The recording material of claim 1, wherein said support is a plastic film or paper.

13. A method for producing an image, comprising the steps of:
(a) providing a thermosensitive recording material, comprising
a thermosensitive coloring layer, wherein said coloring layer comprises
a developer and a dye precursor, wherein said dye precursor comprises a leuco dye dispersion agent, and wherein said leuco dye dispersion agent comprises ethylene oxide and propylene oxide, and
a support; and
(b) treating said thermosensitive recording material with heat under conditions suitable to produce an image.

14. The method of claim 13, wherein said developer is poly(hydroxystyrene).

15. The method of claim 13, wherein said recording material further comprises a co-developer.

16. The method of claim 13, wherein said coloring layer comprises a binder.

17. The method of claim 13, wherein said support is a plastic film or paper.
